(19) United States
(12) Patent Application Publication
(10) Pub. No.: US 2024/0079576 A1
(43) Pub. Date: Mar. 7, 2024

(54) NIOBIUM-TITANIUM-BASED OXIDE, ELECTRODE, SECONDARY BATTERY, BATTERY PACK, VEHICLE, AND STATIONARY POWER SOURCE

(71) Applicant: KABUSHIKI KAISHA TOSHIBA, Tokyo (JP)

(72) Inventors: Kakuya UEDA, Kawasaki Kanagawa (JP); Yoshiaki MURATA, Kawasaki Kanagawa (JP); Yasuhiro HARADA, Isehara Kanagawa (JP); Norio TAKAMI, Yokohama Kanagawa (JP); Shinsuke MATSUNO, Minato Tokyo (JP)

(73) Assignee: KABUSHIKI KAISHA TOSHIBA, Tokyo (JP)

(21) Appl. No.: 18/458,267

(22) Filed: Aug. 30, 2023

(30) Foreign Application Priority Data
Sep. 7, 2022 (JP) 2022-142255
Jan. 30, 2023 (JP) 2023-011957

(51) Int. Cl. H01M 4/485; H01M 10/0525

(52) U.S. Cl. CPC H01M 4/485; H01M 10/0525; H01M 2004/021; H01M 2220/20

(57) ABSTRACT

A niobium-titanium-based oxide includes niobium-titanium-based oxide particles, wherein an Si2p peak area and an Nb3d peak area, as measured by X-ray photoelectron spectroscopy for the niobium-titanium-based oxide particles, satisfy a ratio A of 0.40≤A≤1.0, provided that the ratio A is the Si2p peak area/the Nb3d peak area.

### CROSS-REFERENCE TO RELATED APPLICATIONS

This application is based upon and claims the benefit of priority from Japanese Patent Application No. 2022-142255 filed on Sep. 7, 2022 and Japanese Patent Application No. 2023-011957 filed on Jan. 30, 2023, and the entire contents of which are incorporated herein by reference.

### FIELD

Embodiments described herein relate generally to a niobium-titanium-based oxide, an electrode, a secondary battery, a battery pack, a vehicle, and a stationary power source.

### BACKGROUND

Lithium ion secondary batteries such as a nonaqueous electrolyte battery are rechargeable batteries in which lithium ions move between a positive electrode and a negative electrode to perform charging and discharging.

The positive electrode and the negative electrode hold a nonaqueous electrolyte containing lithium ions.

The nonaqueous electrolyte battery is expected to be used not only as a power source for small electronic devices but also as a medium-to-large power source for in-vehicle applications, stationary applications, and so on.

As an active material of lithium ion secondary battery, use of a niobium-titanium-based oxide has been recently studied. This is because the niobium-titanium-based oxide should have a high charge/discharge capacity.

However, there may be a region highly reactive with the electrolyte in the active material-containing layer of the electrode. Further, a large amount of moisture may remain in the electrode. In these cases, the problem is occurrence of SOC (State Of Charge) shift due to reducing gas, metal elution on the surface of the positive electrode, a decrease in discharge capacity, and others.

To address the problem conventionally, the surface of the active material is treated using a silane coupling agent having a hydrophobic substituent to improve the coverage on the surface of the active material.

However, in terms of the active material containing a niobium-titanium-based oxide, the surface treatment with the silane coupling agent does not cause sufficient covering.

### BRIEF DESCRIPTION OF THE DRAWINGS

FIG. 1 is a schematic view showing a surface of an active material.

FIG. 2 is a schematic view showing a base-treated surface of the active material.

FIG. 3 is a schematic view showing an active material according to the present embodiment, the surface of which is treated with a silane coupling agent.

FIG. 4 is a cross-sectional view schematically showing an example of a secondary battery according to a third embodiment.

FIG. 5 is a cross-sectional view of the secondary battery shown in FIG. 4 and taken along line II-II.

FIG. 6 is a partially cutaway perspective view schematically showing another example of the secondary battery according to the embodiment.

FIG. 7 is an enlarged cross-sectional view of part B in the secondary battery shown in FIG. 6.

FIG. 8 is an exploded perspective view schematically showing an example of an assembled battery according to an embodiment.

FIG. 9 is an exploded perspective view schematically showing an example of a battery pack according to an embodiment.

FIG. 10 is a block diagram illustrating an example of an electric circuit of the battery pack shown in FIG. 9.

FIG. 11 is a partially transparent view schematically illustrating an example of a vehicle according to an embodiment.

FIG. 12 is a diagram schematically illustrating an example of a control system involving an electrical system in a vehicle according to an embodiment.

FIG. 13 is a block diagram illustrating an example of a system including a stationary power source according to an embodiment.

### DETAILED DESCRIPTION

Hereinafter, embodiments will be described with reference to the drawings. In the following description, components that exhibit the same or similar functions are denoted by the same reference numerals throughout all the drawings, and redundant description will be omitted. Note that each drawing is a schematic diagram for promoting the description of each embodiment and the understanding thereof. For example, the shapes, dimensions, and ratios may differ from those of actual devices. However, these designs can be modified, if appropriate, in consideration of the following description and known technologies.

### First Embodiment

The first embodiment provides a niobium-titanium-based oxide comprising niobium-titanium-based oxide particles, wherein an Si2p peak area and an Nb3d peak area, as measured by X-ray photoelectron spectroscopy (XPS), satisfy a ratio A of 0.40≤A≤1.0, provided that the ratio A is the Si2p peak area/the Nb3d peak area. The peak area is the two-dimensional area of the peak. The active material according to the first embodiment may be used as a positive electrode active material or a negative electrode active material. The active material according to the first embodiment is preferably used as a negative electrode active material.

The ratio of the Si2p peak area to the Nb3d peak area as described above represents how much the active material containing Nb is coated with a silane coupling agent. That is, the ratio corresponds to the density of hydrophobic groups on the surface of the active material after surface treatment of the Nb-containing active material. The peak area ratio A described above may be set to 0.40≤A≤1.0 to increase the covering of the active material surface. This can decrease the contact between the active material and aqueous solvent-derived water remained during electrode production. This makes it possible to suppress the SOC shift due to reducing gas. Therefore, the cycle characteristics of the secondary battery can be improved. The peak area ratio A of 0.40 or more means that the coating with the coupling agent is sufficient. Since the active material surface is sufficiently hydrophobic, a decrease in coulombic efficiency can be suppressed. On the other hand, when the peak area ratio A is 1.0 or less, overcoating of the active material surface with the silane coupling agent is prevented. In addition, since the coating portion has low conductivity, as described above, the peak area ratio A is 1.0 or less, so that a decrease in output can be suppressed. Preferably, 0.50≤A≤0.90. This range means that the covering of the active material surface with the silane coupling agent is higher. More preferably, 0.60≤A≤0.80.

For example, the active material surface may be quantitatively analyzed by XPS as follows.

<Method of Quantitatively Analyzing Active Material Surface by XPS>

First, the active material may be contained in the secondary battery. In this case, the secondary battery is brought into a discharged state, and the secondary battery is then disassembled to take out the electrode. This disassembly is performed in a glove box under an inert gas atmosphere such as argon. The discharged state refers to a state in which the battery is discharged until the charge rate of the battery reaches 0%. The taken-out electrode is immersed in a solvent for 3 minutes, and then dried in a glove box under an inert gas atmosphere. As the solvent, for example, diethyl carbonate is used.

Next, the active material powder is collected. The active material powder can be collected, for example, as follows. First, the electrode containing a binder is immersed in a solvent. As the solvent used at this time, for example, N-methylpyrrolidone is used when the binder is an organic solvent-based binder, and pure water is used when the binder is an aqueous binder (e.g., a water-soluble binder). The solvent is irradiated with ultrasonic waves for 30 minutes or longer to disperse the electrode material. This makes it possible to dissolve the binder and separate, as powder, the electrode material from the current collector. Next, a solvent containing the electrode material powder is placed in a centrifugal separator, and separated into a conductive agent and active material particles, which are then collected by freeze drying.

The collected active material is washed with an organic solvent such as a diethyl carbonate solvent to dissolve and remove the lithium salt, and then dried. After drying, the active material is sufficiently washed with water in the air to remove residual lithium ions, and the active material is then used as an analyte.

The XPS measurement may be performed using, for example, a composite electron spectrophotometer. Here, 20 g of the active material particles obtained above is placed in a tableting machine having a diameter of 5 mm, and pressed with a 20 kN weight for 2 minutes for tableting. Here, it is checked that there are, for instance, no cracks in the tablets obtained by pressing, and the powder sample does not scatter or fall off. The tablet obtained in the above step is placed on a carbon tape, and this sample is transferred to an instrument with a dedicated sample holder. The measuring instrument used may be, for example, AXIS-ULTRA manufactured by Kratos Inc., and in the measurement, for example, 300 W monochromated-Al-Kα radiation (1486.6 eV) can be used as an X-ray source. The photoelectron extraction angle is set to 90°. The analysis region is, for example, a rectangle of about 0.6 mm×0.9 mm.

The XPS measurement described above nay be performed to quantitatively analyze elements on the surface of the active material and their states. The obtained measurement results are subjected to background processing.

Specifically, first, the maximum peak value of C1s derived from the carbon tape is corrected to 285.0 eV. Next, for the tablet surface, a peak area, which is the area of region from 203 to 214 eV where the background is subtracted using the Shirley method, is defined as the Nb3d peak area; and similarly, a peak area, which is the area of region from 95 to 110 eV where the background is subtracted using the Shirley method, is defined as the Si2p peak area. From the ratio A between these peak areas (the Si2p peak area/the Nb3d peak area) can be used to calculate the existence ratio between silicon and niobium on the electrode surface.

As a method of improving the covering of the active material surface as described above, it is known that a silane coupling agent (silane compound) can be bonded to the active material surface to make the active material surface hydrophobic. A coupling agent having a hydrophobic substituent such as an alkyl group may be used as the silane coupling agent to prevent water molecules from approaching the active material surface in the secondary battery. As a result, electrolysis of water on the electrode can be suppressed, and cycle characteristics can thus be improved.

However, since the active material according to the conventional technology contains a niobium-titanium-based oxide, the silane coupling agent-treated active material surface had insufficient covering. This is because the amount of hydroxyl group on the active material surface with which the silane coupling agent reacts is not sufficiently large.

By contrast, for the active material according to this embodiment, the niobium-titanium-based oxide-containing active material surface is first treated with a base to increase the density of hydroxyl group on the active material surface. Next, the hydroxyl group is replaced using a silane coupling agent having a hydrophobic group to increase covering of the active material.

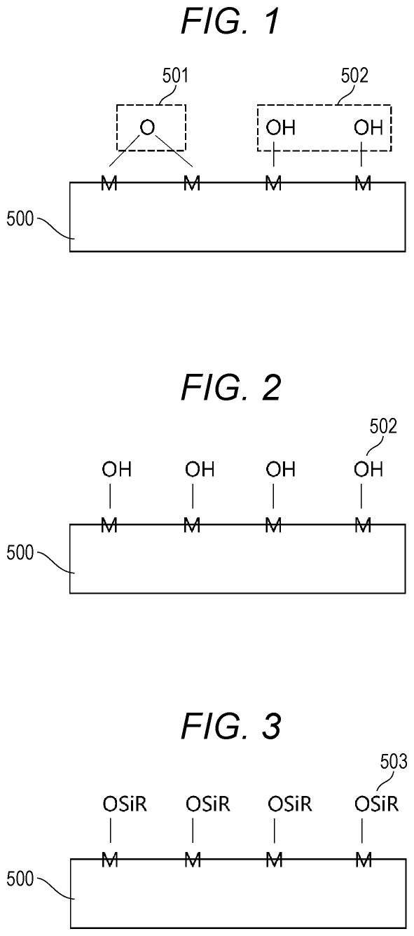

This embodiment will be described with reference to the drawings. FIG. 1 is a schematic view of a surface of an active material. FIG. 2 is a schematic view showing a base-treated surface of the active material. FIG. 3 is a schematic view showing an active material according to this embodiment, the surface of which is treated with a silane coupling agent.

In FIG. 1, the surface of active material 500 according to this embodiment has a hydroxyl group 502 denoted by —OH and an ether bond 501 denoted by —O—. Since they are hydrophilic, water molecules are brought close to the surface of the active material 500.

In FIG. 2, the active material 500 having the ether bond 501 on the surface is treated with a base to increase the density of hydroxyl group 502 on the surface of active material 500. The base treatment of the surface can be performed, for example, as follows.

First, a basic compound and a solvent are mixed and sufficiently stirred to prepare a solution used for base treatment of the active material surface. The solvent used is preferably water. Examples of the basic compound used include NaOH, KOH, LiOH, or NH₄OH. At this time, the concentration of the solution used is from 0.1 to 1.0 mol/L. The concentration of the solution may be set to 0.1 mol/L or more, so that the base treatment is sufficiently performed, and the surface hydroxyl group density of the active material can be increased. When the concentration of the solution is 1.0 mol/L or less, elution of the niobium-titanium-based oxide can be suppressed. The active material to be subjected to the surface base treatment is added to the solution obtained above, and the mixture was heated at a temperature of 45° C. or more and 80° C. or less for 1 hour or more and 24 hours or less while stirring. The base treatment may be carried out at a temperature of 45° C. or more or a stirring time of 1 hour or more. As a result, the base treatment is sufficiently performed, and the surface hydroxyl group density of the active material can be increased. In addition, the base treatment may be carried out at a temperature of 80° C. or less or a stirring time of 24 hours or less. As a result, elution of the niobium-titanium-based oxide can be suppressed.

Thereafter, the solution and the powder are separated by, for instance, filtration to obtain the base-treated active material. The above base treatment enables the surface of the active material according to this embodiment to be sufficiently coated by the surface treatment using silane coupling described later.

In FIG. 3, both the hydroxyl group 502 present before the base treatment and the hydroxyl group 502 that is originally an ether bond 501 but is replaced by the base treatment are each replaced using a silane coupling agent with —OSiR (503) in the drawing. Here, R represents a hydrophobic group. From the above, it can be seen that the covering of the surface of the active material 500 can be improved by once performing the base treatment on the surface of the active material 500 and then performing the silane coupling reaction.

Examples of the silane coupling agent used include an alkyl-based silane coupling agent. Examples of the alkyl-based silane coupling agent include at least one selected from the group consisting of methyltrimethoxysilane, propyltrimethoxysilane, hexyltrimethoxysilane, decyltrimethoxysilane, trimethoxy(3,3,3-trifluoropropyl)silane, dimethyldimethoxysilane, methyltriethoxysilane, and dimethyldiethoxysilane. Among them, the silane coupling agent containing a methyl group, an ethyl group, or a propyl group is preferable because it is easily hydrolyzed and has a large minimum covering area.

In FIG. 3, the compound represented by —OSiR (503) is, for example, an alkyl-based silane compound, and the alkyl-based silane compound contains a hydrophobic group R. The hydrophobic group R is, for example, an alkyl group. The alkyl group is, for example, a C₁₋₁₀ hydrocarbon (hydrocarbon with 1 to 10 carbon atoms). The alkyl group may be linear or branched. The alkyl group is, for example, at least one selected from the group consisting of a methyl group, an ethyl group, a propyl group, a butyl group, a pentyl group, a hexyl group, a heptyl group, an octyl group, a nonyl group, and a decyl group. Some of the hydrogen atoms contained in the alkyl group may be replaced by a group 17 element such as fluorine. The percentage of the number of optionally substituted hydrogen atoms to the number of hydrogen atoms contained in the hydrophobic group R is, for example, in the range of 10% to 100%. The hydrophobic group R may be a trifluoropropyl group.

<Surface Treatment Method by Silane Coupling>

First, a surface treatment agent (alkyl-based silane coupling agent) and an organic solvent as a hydrolysis solvent are mixed, and sufficiently stirred to prepare a solution containing the surface treatment agent. The organic solvent used may be, for example, an alcohol. Next, a dispersion solution in which niobium-titanium oxide particles are dispersed in an organic solvent is obtained. This dispersion solution is admixed with the solution containing the surface treatment agent prepared above, and the mixture is heated while stirring at a temperature of 60° C. to 80° C. for 1 hour to 3 hours. The mixture after the reaction is cooled to room temperature, and the solid content is separated by filtration.

The resulting solid is further washed. The washing can be performed, for example, by stirring the resulting solid in an organic solvent. The organic solvent used may be, for example, an alcohol. The stirring is performed, for example, at room temperature for 0.5 hours to 1.5 hours. Thereafter, the solvent is distilled away to obtain titanium oxide particles, part of which surface is coated with the alkyl-based silane coupling agent.

The niobium-titanium-based oxide according to this embodiment has been subjected to the above surface treatment. The niobium-titanium-based oxide particles are measured by XPS. The ratio A of the Si2p peak area to the Nb3d peak area satisfies 0.40≤A≤1.0. Here, the ratio A is the Si2p peak area/the Nb3d peak area.

The niobium-titanium-based oxide according to this embodiment is at least one selected from the group consisting of a composite oxide represented by general formula LiₓTi_{1-y}M1_{y}Nb_{2-z}M2_{z}O_{7+δ} and a composite oxide represented by general formula LiₓTi_{1-y}M3_{y+z}Nb_{2-z}O_{7-δ}, wherein M1 is at least one selected from the group consisting of Zr, Si, and Sn; M2 is at least one selected from the group consisting of V, Ta, Bi, K, Ca, B, Co, Fe, Mn, Ni, Si, P, and Mo; M3 is at least one selected from Mg, Fe, Ni, Co, W, Ta, and Mo; and 0≤x≤5, 0≤y<1, 0≤z≤2, and −0.3≤δ≤0.3.

The niobium-titanium-based oxide particles may be single primary particles, secondary particles that are aggregates of primary particles, or a mixture of single primary particles and secondary particles. The shape of the particles is not particularly limited, and may be, for example, spherical, elliptical, flat, or fibrous.

In the particle size distribution chart of the niobium-titanium-based oxide particles as obtained by a laser diffraction scattering method, the median diameter D50 is preferably 0.5 μm or more and 4.0 μm or less. The median diameter D50 is a particle diameter [μm] at which a cumulative frequency from a small particle diameter side is 50% in a particle size distribution of active material powder particles as measured by a laser diffraction scattering method, that is, an average particle diameter [μm]. When the median diameter D50 is 0.5 μm or more, an electron conductive path between the active material particles can be sufficiently secured, and a decrease in capacity during charging and discharging can be suppressed. On the other hand, when the median diameter D50 is 4.0 μm or less, the particles can sufficiently withstand a change in lattice constant when Li ions are inserted into and extracted from the active material during charging and discharging. When the primary particles cannot withstand the change in lattice constant described above and crack to increase the specific surface area, side reactions with, for instance, an electrolytic solution increase. Therefore, by setting the median diameter D50 to 4.0 μm or less, deterioration of life characteristics can be suppressed. The median diameter D50 is preferably in the range from 0.5 μm to 2.5 μm. A method for measuring the median diameter of the active material powder particles will be described below.

<Method for Measuring Median Diameter of Active Material Powder Particles>

First, as described in the XPS measurement section, the electrode of interest is disassembled from the secondary battery, and the active material is collected into a powder state. Next, the active material powder is dispersed in water, and the particle size distribution of the constituent particles of the dispersion is measured using a laser diffraction distribution analyzer. It is possible to use, as the laser diffraction distribution analyzer, for example, Microtrac MT 3100 II manufactured by MicrotracBEL Corporation. The ultrasonic processing for obtaining the dispersion described above can be performed with a sample supply system attached to the laser diffraction distribution analyzer. The ultrasonic processing is performed, for example, at an output of 30 W for 60 seconds.

The above measurement may be repeated several times to obtain a volume-based particle size distribution (frequency distribution) chart of the active material particles for each measurement. The median diameter of the active material particles as obtained from the volume-based particle distribution chart for each measurement described above may be averaged. In this way, the median diameter D50 of the active material particles can be calculated and determined.

The active material may contain an active material other than the niobium-titanium-based oxide. Examples of the other active material include ramsdellite structure-containing lithium titanate (e.g., Li_{2+y}Ti₃O₇ where 0≤y≤3), spinel structure-containing lithium titanate (e.g., Li₄₊ₓTi₅O₁₂ where 0≤x≤3), monoclinic titanium dioxide (TiO₂(B)), anatase-type titanium dioxide, rutile-type titanium dioxide, hollandite-type titanium composite oxide, and orthorhombic titanium-containing composite oxide.

Examples of the orthorhombic titanium-containing composite oxide include a compound represented by Li₂₊ₐM(I)_{2-b}Ti_{6-c}M (II) dO_{14+σ}, wherein M(I) is at least one selected from the group consisting of Sr, Ba, Ca, Mg, Na, Cs, Rb, and K; M(II) is at least one selected from the group consisting of Zr, Sn, V, Nb, Ta, Mo, W, Y, Fe, Co, Cr, Mn, Ni, and Al; the respective subscripts in the composition formula satisfy 0≤a≤6, 0≤b<2, 0≤c<6, 0≤d<6, and −0.5≤σ≤0.5. Specific examples of the orthorhombic titanium-containing composite oxide include Li₂₊ₐNa₂Ti₆O₁₄ (0≤a≤6).

The active material may further contain monoclinic titanium dioxide. In this case, electron conductivity is increased as Li ions are inserted more. This leads to a tendency that the charge/discharge rate performance can be improved or the electrode density can be increased by decreasing the amount of conductive auxiliary agent in the electrode.

The above-described first embodiment provides a niobium-titanium-based oxide comprising niobium-titanium-based oxide particles, wherein an Si2p peak area and an Nb3d peak area, as measured by XPS, satisfy a ratio A of 0.40≤A≤1.0, provided that the ratio A is the Si2p peak area/the Nb3d peak area. As a result, the covering of the surface of the active material can be increased, and the moisture content can be lowered. In addition, a secondary battery including the active material according to the first embodiment can have improved cycle characteristics.

According to the embodiment, an active material that improves cycle characteristics of a secondary battery is provided.

### Second Embodiment

The second embodiment provides an electrode containing the niobium-titanium-based oxide according to the first embodiment in an active material. The electrode according to the second embodiment includes a current collector and an active material-containing layer supported on at least one main surface of the current collector. The active material-containing layer contains the above active material. The active material-containing layer may further contain a conductive agent and a binder.

The following details the electrode according to the second embodiment.

1) Active Material

The case of using the niobium-titanium-based oxide according to the first embodiment as the negative electrode active material is as described above. When the niobium-titanium-based oxide particles are measured by XPS, the ratio A of the Si2p peak area to the Nb3d peak area satisfies 0.40≤A≤1.0.

2) Binder

The binder exerts an effect such that the active material, the conductive agent, and the current collector are bound. Examples of the binder include polytetrafluoroethylene (PTFE), polyvinylidene fluoride (PVdF), polyvinyl butyral (PVB), fluororubber, styrene-butadiene rubber, a polyacrylic acid compound, an imide compound, carboxymethyl cellulose (CMC), or a salt of CMC. The kind of the binder may be one kind or two or more kinds.

In the negative electrode active material-containing layer, the binder is preferably blended in a ratio of 2 mass % or more and 20 mass % or less. By setting the amount of the binder to 2 mass % or more, sufficient electrode strength can be obtained. In addition, the binder may function as an insulator. Therefore, when the amount of the binder is 20 mass % or less, the amount of insulator contained in the electrode is reduced, so that the internal resistance can be decreased.

The amount of binder blended with 100 parts by mass of the active material is preferably more than 0 parts by mass and 10 parts by mass or less, and more preferably 1 part by mass or more and 5 parts by mass or less. When the amount of binder is large, the efficiency of binding between the active material-containing layer and the current collector becomes sufficient, and excellent cycle performance can thus be expected. On the other hand, when the amount of binder is excessively large, the energy density may decrease.

3) Conductive Agent

The conductive agent is optionally blended in order to enhance current collection performance and suppress contact resistance between the active material and the current collector.

Examples of the conductive agent include a vapor grown carbon fiber (VGCF), carbon black such as acetylene black, a carbon substance such as graphite, or carbon powder. The kind of the conductive agent may be one kind or two or more kinds. Alternatively, instead of using the conductive material, carbon coating or electron conductive inorganic material coating may be applied to the surface of the active material. In addition, when carbon powder is used as the conductive agent, the fluidity of the active material is improved, so that the electrode density can be increased.

When the conductive agent is added, the negative electrode active material, the binder, and the conductive agent are preferably blended in proportions of 77 mass % or more and 95 mass % or less, 2 mass % or more and 20 mass % or less, and 3 mass % or more and 15 mass % or less, respectively. By setting the amount of the conductive agent to 3 mass % or more, the above-described effect can be elicited. When the amount of the conductive agent is 15 mass % or less, the proportion of the conductive agent in contact with the electrolytic solution can be lowered. When this proportion is low, decomposition of the electrolytic solution can be decreased under high-temperature storage.

4) Current Collector

It is possible to use, as the current collector, a material that is electrochemically stable at a potential at which lithium (Li) is inserted into and extracted from the active material. For example, when the active material is used as the negative electrode active material, the current collector is preferably made of copper, nickel, stainless steel, or aluminum, or an aluminum alloy containing one or more elements selected from the group consisting of Mg, Ti, Zn, Mn, Fe, Cu, and Si. The current collector has a thickness of preferably 5 μm or more and 20 μm or less. The current collector having such a thickness can balance the strength and weight reduction of the electrode.

In addition, the current collector may include a surface portion where the active material-containing layer is not formed. This portion can act as a current collecting tab.

The density of the active material-containing layer is preferably 3.0 g/cm³ or more and 3.6 g/cm³ or less, and more preferably 3.2 g/cm³ or more and 3.5 g/cm³ or less.

As described, the current collector may include a surface portion where the active material-containing layer is not formed. This portion can act as a current collecting tab.

The electrode can be produced, for example, by the following procedure. First, the active material, the conductive agent, and the binder are suspended in a solvent to prepare a slurry. This slurry is applied to one surface or both surfaces of the current collector. Next, the applied slurry is dried to obtain a laminate of the active material-containing layer and the current collector. Thereafter, the laminate is pressed. In this way, an electrode is produced.

Alternatively, the electrode may be produced by the following procedure. First, the active material, the conductive agent, and the binder are mixed to prepare a mixture. Then, the mixture is formed into pellets. Then, these pellets are disposed on the current collector. In this way, an electrode can be obtained.

The electrode according to the second embodiment described above contains the active material according to the first embodiment. Thus, a secondary battery including the electrode according to the second embodiment can have improved cycle characteristics.

### Third Embodiment

The third embodiment provides a secondary battery including a negative electrode, namely the electrode according to the second embodiment, a positive electrode, and an electrolyte.

The secondary battery according to the third embodiment may further include a separator disposed between the positive electrode and the negative electrode. The negative electrode, the positive electrode, and the separator can constitute an electrode group. The electrolyte can be held in the electrode group.

In addition, the secondary battery according to the third embodiment may further include an exterior member configured to house the electrode group and the electrolyte.

Further, the secondary battery according to the second embodiment may further include a negative electrode terminal electrically connected to the negative electrode and a positive electrode terminal electrically connected to the positive electrode.

The secondary battery according to the third embodiment may be, for example, a lithium ion secondary battery. In addition, the secondary battery includes a nonaqueous electrolyte secondary battery containing a nonaqueous electrolyte.

The following details the positive electrode, the electrolyte, the separator, the exterior member, the negative electrode terminal, and the positive electrode terminal, assuming that the electrode according to the second embodiment is used as the negative electrode.

1) Positive Electrode

The positive electrode may include a positive electrode current collector and a positive electrode active material-containing layer. The positive electrode active material-containing layer may be formed on one surface or both surfaces of the positive electrode current collector. The positive electrode active material-containing layer can contain a positive electrode active material, and optionally a conductive agent and a binder.

Examples of the positive electrode active material include a lithium-manganese composite oxide, a lithium-nickel composite oxide, a lithium-cobalt-aluminum composite oxide, a lithium-nickel-cobalt-manganese composite oxide, a spinel-type lithium-manganese-nickel composite oxide, a lithium-manganese-cobalt composite oxide, a lithium iron oxide, a lithium fluorinated iron sulfate, or a phosphate compound having an olivine crystal structure (e.g., LiₓFePO₄ (0<x≤1), LiₓMnPO₄ (0<x≤1)). The phosphate compound having an olivine crystal structure is excellent in thermal stability.

Examples of the active material capable of producing a high electrode potential include: a lithium-manganese composite oxide having a spinel structure (e.g., LiₓMn₂O₄ (0<x≤1), LiₓMnO₂ (0<x≤1)); a lithium nickel aluminum composite oxide (e.g., LiₓNi_{1-y}Al_{y}O₂ (0<x≤1, 0<y<1)); a lithium-cobalt composite oxide (e.g., LixCoO₂ (0<x≤1)); a lithium-nickel-cobalt composite oxide s (e.g., LiₓNi_{1-y-z}CoMn_{z}O₂ (0<x≤1, 0<y<1, 0≤z<1)); a lithium-manganese-cobalt complex oxide (e.g., LiₓMn_{y}Co_{1-y}O₂ (0<x≤1, 0<y<1)); a spinel-type lithium-manganese-nickel complex oxide (e.g., LiₓMn_{1-y}Ni_{y}O₄ (0<x≤1, 0<y<2, 0<1−y<1)); a lithium phosphorus oxide having an olivine structure (e.g., LiₓFePO₄ (0<x≤1), LiₓFe_{1-y}Mn_{y}PO₄ (0<x≤1, 0≤y≤1), LiₓCoPO₄ (0<x≤1)); or a fluorinated iron sulfate (e.g., LiₓFeSO₄F (0<x≤1)).

The positive electrode active material is preferably at least one selected from the group consisting of a lithium-cobalt composite oxide, a lithium-manganese composite oxide, and a lithium phosphorus oxide having an olivine structure. The operating potentials of these active materials are 3.5 V (vs. Li/Li⁺) or more and 4.2 V (vs. Li/Li⁺) or less. That is, the operating potentials of these positive electrode active materials are relatively high.

In the positive electrode active material-containing layer, the positive electrode active material is preferably blended in a ratio of 80 mass % or more and 98 mass % or less.

Since the binder, the conductive agent, which may be contained in the positive electrode active material-containing layer, and the current collector, have been described above, the description thereof is omitted here. Similarly, since the example of the method for producing an electrode has been described above, the method for producing the positive electrode is omitted here.

2) Electrolyte

As the electrolyte, for example, a liquid nonaqueous electrolyte or a gel nonaqueous electrolyte can be used. The liquid nonaqueous electrolyte is prepared by dissolving an electrolyte salt as a solute in an organic solvent. The concentration of the electrolyte salt is preferably 0.5 mol/L or more and 2.5 mol/L or less.

Examples of the electrolyte salt include lithium perchlorate (LiClO₄), lithium hexafluorophosphate (LiPF₆), lithium tetrafluoroborate (LiBF₄), lithium arsenic hexafluoride (LiAsF₆), lithium trifluoromethanesulfonate (LiCF₃SO₃), lithium bistrifluoromethylsulfonylimide (LiN(CF₃SO₂)₂), or lithium bis (fluorosulfonyl) imide (LiN(SO₂F)₂; LiFSI), or a mixture thereof. The electrolyte salt is preferably hardly oxidized even at a high potential, and is most preferably LiPF₆.

Examples of the organic solvent include cyclic carbonate (e.g., propylene carbonate (PC), ethylene carbonate (EC), vinylene carbonate (VC)); chain carbonate (e.g., diethyl carbonate (DEC), dimethyl carbonate (DMC), methyl ethyl carbonate (MEC)); cyclic ether (e.g., tetrahydrofuran (THF), 2-methyl tetrahydrofuran (2MeTHF), dioxolane (DOX)); chain ether (e.g., dimethoxyethane (DME), diethoxy ethane (DEE)); or γ-butyrolactone (GBL), acetonitrile (AN), or sulfolane (SL). These organic solvents may be used singly or as a mixed solvent.

The gel nonaqueous electrolyte is prepared by making a composite of a liquid nonaqueous electrolyte and a polymer material. Examples of the polymer material include polyvinylidene fluoride (PVdF), polyacrylonitrile (PAN), polyethylene oxide (PEO), or a mixture thereof.

Alternatively, it is possible to use, as the nonaqueous electrolyte, instead of the liquid nonaqueous electrolyte and the gel nonaqueous electrolyte, a lithium ion-containing normal temperature molten salt (ionic melt), a polymer solid electrolyte, an inorganic solid electrolyte, or the like.

The normal temperature molten salt (ionic melt) refers to a compound that can exist as a liquid at normal temperature (15° C. or higher and 25° C. or lower) among organic salts composed of an organic cation/anion combination. The normal temperature molten salt includes a normal temperature molten salt which exists alone as a liquid, a normal temperature molten salt which becomes a liquid by being mixed with an electrolyte salt, a normal temperature molten salt which becomes a liquid by being dissolved in an organic solvent, or a mixture thereof. In general, the normal temperature molten salt used in a secondary battery has a melting point of 25° C. or lower. In addition, the organic cation generally has a quaternary ammonium skeleton.

Alternatively, instead of the nonaqueous electrolyte, a liquid aqueous electrolyte or a gel aqueous electrolyte may be used as the electrolyte. The liquid aqueous electrolyte is prepared, for example, by dissolving the above electrolyte salt as a solute in an aqueous solvent. The gel aqueous electrolyte is prepared by making a composite of a liquid aqueous electrolyte and the above polymer material. As the aqueous solvent, a solution containing water may be used. The solution containing water may be pure water or a mixed solvent of water and an organic solvent.

3) Separator

The separator is not particularly limited as long as the positive electrode and the negative electrode are electrically insulated from each other. The separator is formed of, for example, a porous film or synthetic resin nonwoven fabric, containing polyethylene (PE), polypropylene (PP), cellulose, or polyvinylidene fluoride (PVdF). From the viewpoint of safety, it is preferable to use a porous film made of polyethylene or polypropylene. This is because these porous films can melt at a given temperature and block the current.

4) Exterior Member

As the exterior member, for example, a container made of a laminate film or a metal exterior can may be used.

The laminate film has a thickness of, for example, 0.5 mm or less, and preferably 0.2 mm or less.

It is possible to use, as the laminate film, a multilayer film including a plurality of resin layers and a metal layer interposed between the resin layers. The resin layer may be made of, for example, polypropylene (PP), polyethylene (PE), nylon, or polyethylene terephthalate (PET). The metal layer is preferably made of an aluminum foil or an aluminum alloy foil for weight reduction. The laminate film may be formed into the shape of the exterior member by performing sealing by thermal fusion.

The thickness of the wall of the exterior can is, for example, 1 mm or less, more preferably 0.5 mm or less, and still more preferably 0.2 mm or less.

The exterior can is made of, for example, aluminum or an aluminum alloy. The aluminum alloy preferably contains elements such as magnesium, zinc, and/or silicon. When the aluminum alloy contains a transition metal such as iron, copper, nickel, or chromium, the content thereof is preferably 1 mass % or less.

The shape of the exterior member is not particularly limited. The shape of the exterior member may be, for example, a flat shape (thin shape), a square shape, a cylindrical shape, a coin shape, or a button shape. The exterior member may be selected, if appropriate, according to the size of the battery and the application of the battery.

5) Negative Electrode Terminal

The negative electrode terminal may be formed of a conductive material that is electrochemically stable in a potential range of 0.8 V or more and 3 V or less with respect to the oxidation-reduction potential of lithium (vs. Li/Li⁺). Specifically, examples of the material for the negative electrode terminal include copper, nickel, stainless steel, aluminum, or an aluminum alloy containing at least one element selected from the group consisting of Mg, Ti, Zn, Mn, Fe, Cu, and Si. As the material for the negative electrode terminal, aluminum or an aluminum alloy is preferably used. The negative electrode terminal is preferably made of the same material as the negative electrode current collector in order to reduce contact resistance to the negative electrode current collector.

6) Positive Electrode Terminal

The positive electrode terminal may be formed of a conductive material that is electrically stable in a potential range of 3 V or more and 4.5 V or less with respect to the oxidation-reduction potential of lithium (vs. Li/Li⁺). Specifically, examples of the material for the positive electrode terminal include aluminum, or an aluminum alloy containing at least one element selected from the group consisting of Mg, Ti, Zn, Mn, Fe, Cu, and Si. The positive electrode terminal is preferably made of the same material as the positive electrode current collector in order to reduce contact resistance to the positive electrode current collector.

Hereinafter, the secondary battery according to this embodiment will be described more specifically with reference to the drawings.

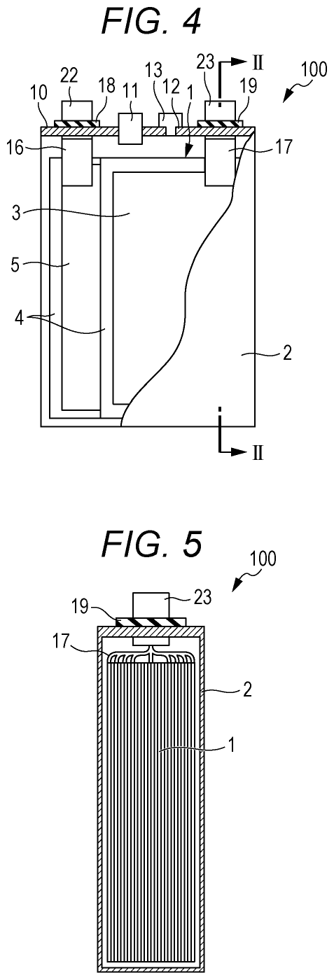

FIG. 4 is a cross-sectional view schematically showing an example of a secondary battery according to the third embodiment. FIG. 5 is a cross-sectional view of the secondary battery shown in FIG. 4 and taken along line II-II.

An electrode group 1 is housed in a rectangular cylindrical metal container 2. The electrode group 1 has, for example, a structure in which a plurality of positive electrodes 5, negative electrodes 3, and separators 4 are layered in the order of the positive electrode 5, the separator 4, the negative electrode 3, and the separator 4. Alternatively, the electrode group 1 may have a structure in which the positive electrode 5 and the negative electrode 3 are spirally wound so as to have a flat shape with the separator 4 interposed therebetween. In any of the electrode group 1 structures, it is desirable to have a structure in which the separator 4 is disposed on the outermost layer of the electrode group 1 in order to avoid contact between each electrode and the metal container 2. The electrode group 1 holds an electrolyte (not shown).

As shown in FIG. 5, a belt-shaped negative electrode tab 17 is electrically connected to each of a plurality of the end portions of the negative electrode 3 and is located on an end surface of the electrode group 1. Although not shown, a belt-shaped positive electrode tab 16 is electrically connected to each of a plurality of the end portions of the positive electrode 5 and is located on the end surface. The plurality of negative electrode tabs 17 are electrically connected in a bundled state to the negative electrode lead 23. The negative electrode tabs 17 (negative electrode internal terminals) and the negative electrode lead 23 (negative electrode external terminal) constitute a negative electrode terminal. In addition, the positive electrode tabs 16 are connected in a bundled state to the positive electrode lead 22. The positive electrode tabs 16 (positive electrode internal terminals) and the positive electrode lead 22 (positive electrode external terminal) constitute a positive electrode terminal.

The metal sealing plate 10 is fixed to the opening of the metal container 2 by, for instance, welding. The positive electrode lead 22 and the negative electrode lead 23 are each extracted to the outside through an extraction hole provided in the sealing plate 10. In order to avoid a short circuit due to contact with the positive electrode lead 22 or the negative electrode lead 23, a positive electrode gasket 18 or a negative electrode gasket 19 is disposed on the inner peripheral surface of each extraction hole of the sealing plate 10. The positive electrode gasket 18 and the negative electrode gasket 19 are placed to maintain airtightness of the rectangular secondary battery.

The sealing plate 10 is provided with a control valve 11 (safety valve). When the internal pressure of the battery cell increases due to gas generated by electrolysis of the aqueous solvent, the generated gas can be diffused to the outside from the control valve 11. It is possible to use, as the control valve 11, for example, a return type valve that operates when the internal pressure becomes higher than a preset value and functions as a sealing plug when the internal pressure decreases. Alternatively, it is possible to use a non-return type control valve in which the function as a sealing plug is not restored once operated. In FIG. 4, the control valve 11 is disposed at the center of the sealing plate 10, but the position of the control valve 11 may be at the edge of the sealing plate 10. The control valve 11 may be omitted.

In addition, the sealing plate 10 is provided with a liquid injection port 12. The electrolyte can be injected through the liquid injection port 12. The liquid injection port 12 is closed by a sealing plug 13 after the electrolyte solution is filled therein. The liquid injection port 12 and the sealing plug 13 may be omitted.

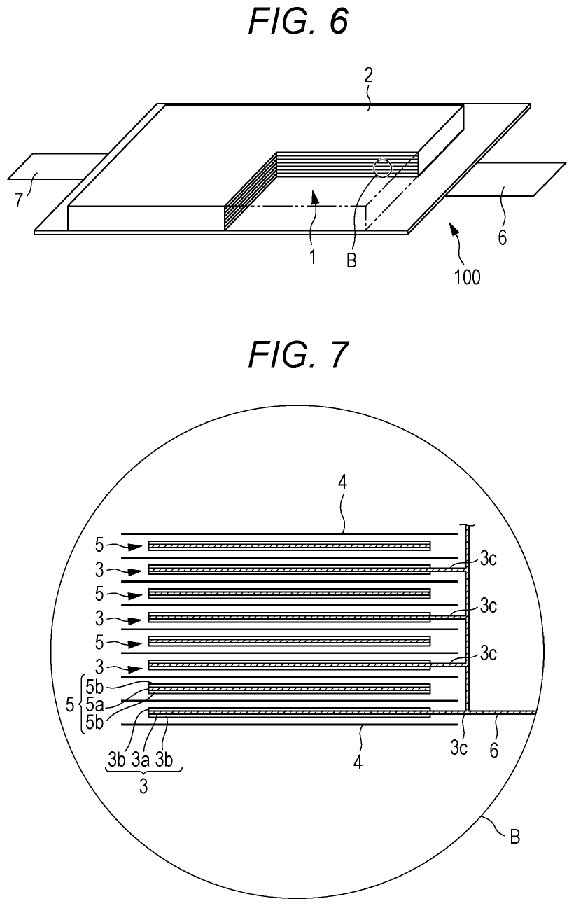

The secondary battery according to the third embodiment is not limited to the secondary battery having the configuration shown in FIGS. 4 and 5, and may be, for example, a battery having the configuration shown in FIGS. 6 and 7.

FIG. 6 is a partially cutaway perspective view schematically showing another example of the secondary battery according to this embodiment. FIG. 7 is an enlarged cross-sectional view of part B in the secondary battery shown in FIG. 6.

The secondary battery 100 shown in FIGS. 6 and 7 includes an electrode group 1 shown in FIGS. 6 and 7, an exterior member 2 shown in FIG. 6, and an electrolyte (not shown). The electrode group 1 and the electrolyte are housed in the exterior member 2. The electrolyte can be held in the electrode group 1.

The exterior member 2 is made of a laminate film including two resin layers and a metal layer interposed therebetween.

An electrode group 1 illustrated in FIG. 7 is a laminated electrode group. The laminated electrode group 1 has a structure in which the negative electrode 3 and the positive electrode 5 are alternately layered with the separator 4 interposed therebetween.

The electrode group 1 includes a plurality of negative electrodes 3. Each of the plurality of negative electrodes 3 includes a negative electrode current collector 3a and negative electrode active material-containing layers 3b disposed on both surfaces of the negative electrode current collector 3a. In addition, the electrode group 1 includes a plurality of positive electrodes 5. Each of the plurality of positive electrodes 5 includes a positive electrode current collector 5a and positive electrode active material-containing layers 5b disposed on both surfaces of the positive electrode current collector 5a.

The negative electrode current collector 3a of each negative electrode 3 includes, on one side thereof, a portion 3c where the negative electrode active material-containing layer 3b is not disposed on any surface. This portion 3c can act as a negative electrode current collecting tab. As shown in FIG. 7, the portion 3c serving as the negative electrode current collecting tab does not overlap with the positive electrode 5. The plurality of negative electrode current collecting tabs (portions 3c) are electrically connected to a belt-shaped negative electrode terminal 6. The tip of the belt-shaped negative electrode terminal 6 is extracted to the outside of the exterior member 2.

Although not shown, the positive electrode current collector 5a of each positive electrode 5 includes, on one side thereof, a portion where the positive electrode active material-containing layer 5b is not disposed on any surface. This portion can act as a positive electrode current collecting tab. The positive electrode tab does not overlap the negative electrode 3, similarly to the negative electrode tab (portion 3c). In addition, the positive electrode tab is located on a side opposite to the negative electrode tab (portion 3c) of the electrode group 1. The positive electrode tab is electrically connected to a belt-shaped positive electrode terminal 7. The tip of the belt-shaped positive electrode terminal 7 is located on the side opposite to the negative electrode terminal 6 and is extracted to the outside of the exterior member 2.

The secondary battery according to the third embodiment may constitute an assembled battery. The assembled battery includes a plurality of secondary batteries according to this embodiment.

In the assembled battery according to the third embodiment, the respective unit cells may be electrically connected in series or in parallel, or may be arranged in combination of serially connected and parallelly connected cells.

An example of the assembled battery according to this embodiment will be described with reference to the drawings.

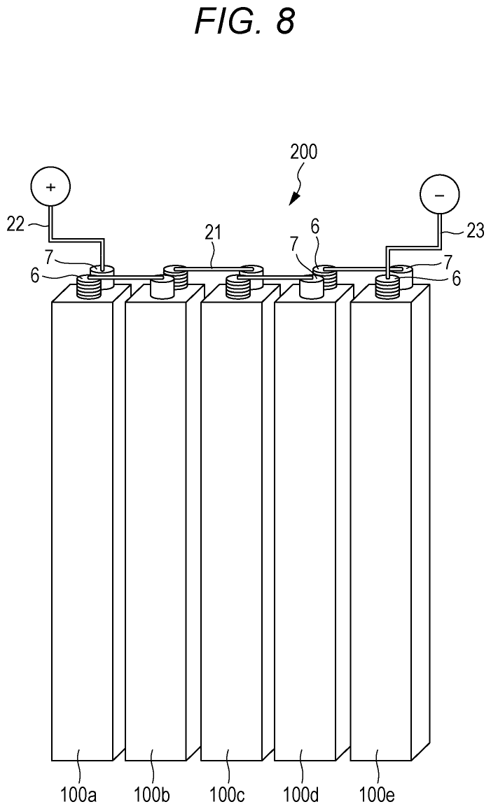

FIG. 8 is a perspective view schematically showing an example of an assembled battery according to this embodiment. The assembled battery 200 shown in FIG. 8 includes five unit cells 100a to 100e, four bus bars 21, a positive electrode-side lead 22, and a negative electrode-side lead 23. The five unit cells 100a to 100e are each the secondary battery according to this embodiment.

The bus bar 21 connects, for example, the negative electrode terminal 6 of one unit cell 100a and the positive electrode terminal 7 of the unit cell 100b located adjacent to the unit cell 100a. In this way, the five unit cells 100 are connected in series by the four bus bars 21. That is, the assembled battery 200 of FIG. 8 is an assembled battery with five serially connected cells.

As shown in FIG. 8, among the five unit cells 100a to 100e, the positive electrode terminal 7 of the unit cell 100a located at the left end is connected to the positive electrode-side lead 22 for external connection. In addition, among the five unit cells 100a to 100e, the negative electrode terminal 6 of the unit cell 100e located at the right end is connected to the negative electrode-side lead 23 for external connection.

The secondary battery according to the third embodiment includes a negative electrode, namely the electrode according to the second embodiment, a positive electrode, and an electrolyte. As a result, this secondary battery can achieve excellent cycle characteristics.

### Fourth Embodiment

The fourth embodiment provides a battery pack including the secondary battery according to the third embodiment. This battery pack may include one secondary battery according to the third embodiment, or may include an assembled battery including a plurality of the secondary batteries.

The battery pack according to this embodiment may further include a protection circuit. The protection circuit functions to control charging and discharging of the secondary battery. Alternatively, a circuit included in a device (e.g., an electronic device, an automobile,) using the battery pack as a power source may be used as a protection circuit of the battery pack.

In addition, the battery pack according to this embodiment may further include an external power distribution terminal (external terminal for energization). The external power distribution terminal is for outputting a current from the secondary battery to the outside and/or for inputting a current from the outside to the secondary battery. In other words, when the battery pack is used as a power source, a current is supplied to the outside through the external power distribution terminal. In addition, when the battery pack is charged, a charging current (including regenerative energy for power of, for instance, an automobile) is supplied to the battery pack through the external power distribution terminal.

Next, an example of the battery pack according to this embodiment will be described with reference to the drawings.

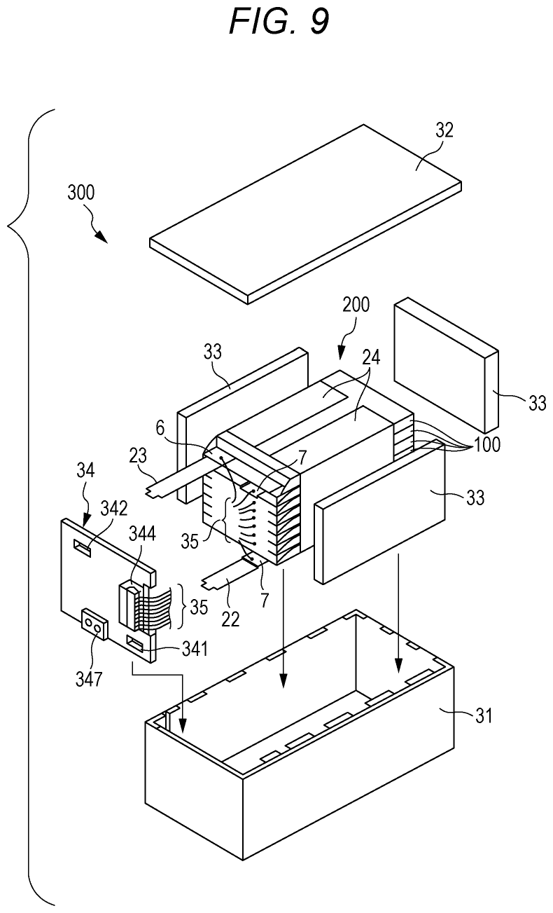

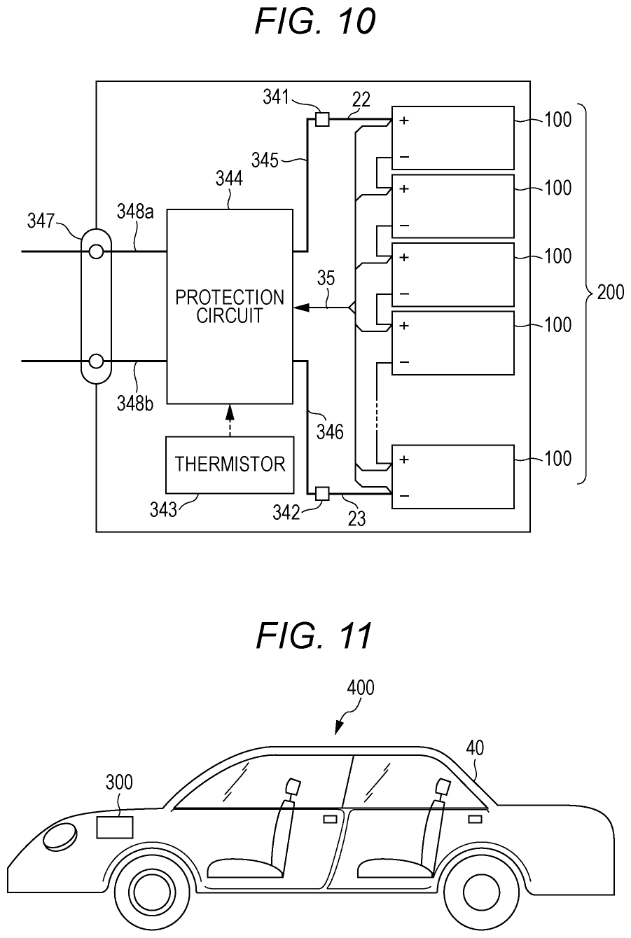

FIG. 9 is an exploded perspective view schematically showing an example of a battery pack according to this embodiment. FIG. 10 is a block diagram illustrating an example of an electric circuit of the battery pack shown in FIG. 9.

A battery pack 300 shown in FIGS. 9 and 10 includes a housing container 31, a lid 32, protective sheets 33, an assembled battery 200, a printed circuit board 34, wiring 35, and an insulating plate (not shown).

The housing container 31 illustrated in FIG. 9 is a bottomed square container having a rectangular bottom surface. The housing container 31 is configured to be able to house the protective sheets 33, the assembled battery 200, the printed circuit board 34, and the wiring 35. The lid 32 has a rectangular shape. The lid 32 covers the housing container 31 to house, for example, the assembled battery 200. Although not illustrated, the housing container 31 and the lid 32 are provided with, for instance, an opening or a connection terminal for connection to an external device or the like.

The assembled battery 200 includes a plurality of unit cells 100, a positive electrode-side lead 22, a negative electrode-side lead 23, and an adhesive tape 24.

The unit cell 100 has a structure shown in FIGS. 4 and 5. At least one of the plurality of unit cells 100 is the secondary battery according to the third embodiment. The plurality of unit cells 100 are stacked in an aligned manner such that the negative electrode terminal 6 and the positive electrode terminal 7 extending to the outside are in the same direction. The respective unit cells 100 are electrically connected in series as shown in FIG. 10. The plurality of unit cells 100 may be electrically connected in parallel, or may be connected in combination of serially connected and parallelly connected cells. The case where the plurality of unit cells 100 are connected in parallel has a larger battery capacity than the case where they are connected in series.

The adhesive tape 24 fastens the plurality of unit cells 100. Instead of the adhesive tape 24, a heat-shrinkable tape may be used to secure the unit cells 100. In this case, the protective sheets 33 are disposed on both side surfaces of the assembled battery 200, the heat-shrinkable tape is wound around, and then the heat-shrinkable tape is heat-shrunk to bind the plurality of unit cells 100.

One end of the positive electrode-side lead 22 is connected to the positive electrode terminal 7 of the unit cell 100 positioned at the lowermost layer in the laminate of the unit cells 100. One end of the negative electrode-side lead 23 is connected to the negative electrode terminal 6 of the unit cell 100 positioned at the uppermost layer in the laminate of the unit cells 100.

The printed circuit board 34 is placed along one of the inner surfaces in the short-side direction of the housing container 31. The printed circuit board 34 includes a positive electrode side connector 341, a negative electrode side connector 342, a thermistor 343, a protection circuit 344, wirings 345 and 346, an external power distribution terminal 347, a plus-side wiring 348a, and a minus-side wiring 348b. One main surface of the printed circuit board 34 faces a surface from which the negative electrode terminal 6 and the positive electrode terminal 7 is projected in the assembled battery 200. An insulating plate (not shown) is interposed between the printed circuit board 34 and the assembled battery 200.

The positive electrode side connector 341 has a through hole. When the other end of the positive electrode-side lead 22 is inserted into the through hole, the positive electrode side connector 341 and the positive electrode-side lead 22 are electrically connected. The negative electrode side connector 342 has a through hole. When the other end of the negative electrode-side lead 23 is inserted into the through hole, the negative electrode side connector 342 and the negative electrode-side lead 23 are electrically connected.

The thermistor 343 is fixed to one main surface of the printed circuit board 34. The thermistor 343 detects the temperature of each of the unit cells 100 and transmits a detection signal thereof to the protection circuit 344.

The external power distribution terminal 347 is fixed to the other main surface of the printed circuit board 34. The external power distribution terminal 347 is electrically connected to a device existing outside the battery pack 300.

The protection circuit 344 is fixed to the other main surface of the printed circuit board 34. The protection circuit 344 is connected to the external power distribution terminal 347 via the plus-side wiring 348a. The protection circuit 344 is connected to the external power distribution terminal 347 via the minus-side wiring 348b. In addition, the protection circuit 344 is electrically connected to the positive electrode side connector 341 via the wiring 345. The protection circuit 344 is electrically connected to the negative electrode side connector 342 via the wiring 346. Further, the protection circuit 344 is electrically connected to each of the plurality of unit cells 100 via the wiring 35.

The protective sheets 33 are disposed on both the inner side surfaces in the long side direction of the housing container 31 and an inner side surface that is in the short side direction and faces the printed circuit board 34 via the assembled battery 200. The protective sheet 33 is made of, for example, resin or rubber.

The protection circuit 344 controls charging and discharging of the plurality of unit cells 100. In addition, the protection circuit 344 interrupts the electrical connection between the protection circuit 344 and the external power distribution terminal 347 on the basis of the detection signal transmitted from the thermistor 343 or the detection signal transmitted from each of the unit cells 100 or the assembled battery 200.

Examples of the detection signal transmitted from the thermistor 343 include a signal obtained by detecting that the temperature of the unit cell 100 is equal to or higher than a predetermined temperature. Examples of the detection signal transmitted from each of the unit cells 100 or the assembled battery 200 include a signal obtained by detecting overcharge, overdischarge, and overcurrent of each unit cell 100. When overcharge, for instance, is detected for each unit cell 100, a battery voltage may be detected, or a positive electrode potential or a negative electrode potential may be detected. In the latter case, a lithium electrode used as a reference electrode is inserted into each unit cell 100. Note that it is possible to use, as the protection circuit 344, a circuit included in a device (e.g., an electronic device, an automobile) using the battery pack 300 as a power source.

As described above, the battery pack 300 includes the external power distribution terminal 347. Therefore, the battery pack 300 can output the current from the assembled battery 200 to the external device and input the current from the external device to the assembled battery 200 via the external power distribution terminal 347. In other words, when the battery pack 300 is used as a power source, the current from the assembled battery 200 is supplied to the external device through the external power distribution terminal 347. In addition, when the battery pack 300 is charged, a charging current from the external device is supplied to the battery pack 300 through the external power distribution terminal 347. When the battery pack 300 is used as an in-vehicle battery, regenerative energy for power of the vehicle can be used as a charging current from the external device.

Note that the battery pack 300 may include a plurality of assembled batteries 200. In this case, the plurality of assembled batteries 200 may be connected in series, connected in parallel, or connected in combination of serially connected and parallelly connected assembled batteries. In addition, the printed circuit board 34 and the wiring 35 may be omitted. In this case, the positive electrode-side lead 22 and the negative electrode-side lead 23 may be used as external power distribution terminals.

Such a battery pack is used, for example, for applications requiring excellent cycle performance when a large current is extracted. Specifically, this battery pack is used as, for example, a power source of an electronic device, a stationary battery, and an in-vehicle battery of various vehicles. Examples of the electronic device include a digital camera. This battery pack is particularly suitably used as an in-vehicle battery.

The battery pack according to the fourth embodiment includes the secondary battery according to the third embodiment. As a result, this battery pack can achieve excellent cycle characteristics.

### Fifth Embodiment

The fifth embodiment provides a vehicle on which the battery pack according to the fourth embodiment is mounted.

In the vehicle according to the fifth embodiment, the battery pack recovers, for example, regenerative energy for power of the vehicle. The vehicle may include a mechanism (regenerator) that converts kinetic energy of the vehicle into regenerative energy.

Examples of the vehicle according to the fifth embodiment include a two-wheel to four-wheel hybrid electric vehicle, a two-wheel to four-wheel electric vehicle, an assist bicycle, or a railway vehicle.

Where the battery pack is mounted in the vehicle according to the fifth embodiment is not particularly limited. For example, when the battery pack is mounted on an automobile, the battery pack may be mounted in an engine room of the vehicle, rearwardly of the vehicle body, or under a seat.

The vehicle according to the fifth embodiment may be equipped with a plurality of battery packs. In this case, the batteries included in the respective battery packs may be electrically connected in series, electrically connected in parallel, or may be electrically connected in combination of serially connected and parallelly connected batteries. For example, when each battery pack includes an assembled battery, the assembled batteries may be electrically connected in series, or electrically connected in parallel, or may be electrically connected in combination of serially connected and parallelly connected assembled batteries. Alternatively, when each battery pack includes unit cells, the respective cells may be electrically connected in series, electrically connected in parallel, or may be electrically connected in combination of serially connected and parallelly connected cells.

Next, an example of the vehicle according to the fifth embodiment will be described with reference to the drawings.

FIG. 11 is a partially transparent view schematically illustrating an example of a vehicle according to the fifth embodiment. A vehicle 400 illustrated in FIG. 11 includes a vehicle body 40 and a battery pack 300 according to the fourth embodiment. In the example illustrated in FIG. 11, the vehicle 400 is a four-wheel automobile.

The vehicle 400 may be equipped with a plurality of battery packs 300. In this case, the batteries (e.g., unit cells or assembled batteries) included in the battery pack 300 may be connected in series, connected in parallel, or connected in combination of serially connected and parallel connected batteries.

FIG. 11 depicts an example in which the battery pack 300 is mounted in an engine room located forwardly of the vehicle body 40. As described above, the battery pack 300 may be mounted, for example, rearwardly of the vehicle body 40 or under a seat. The battery pack 300 can be used as a power source of the vehicle 400. In addition, the battery pack 300 can recover regenerative energy for the power of the vehicle 400.

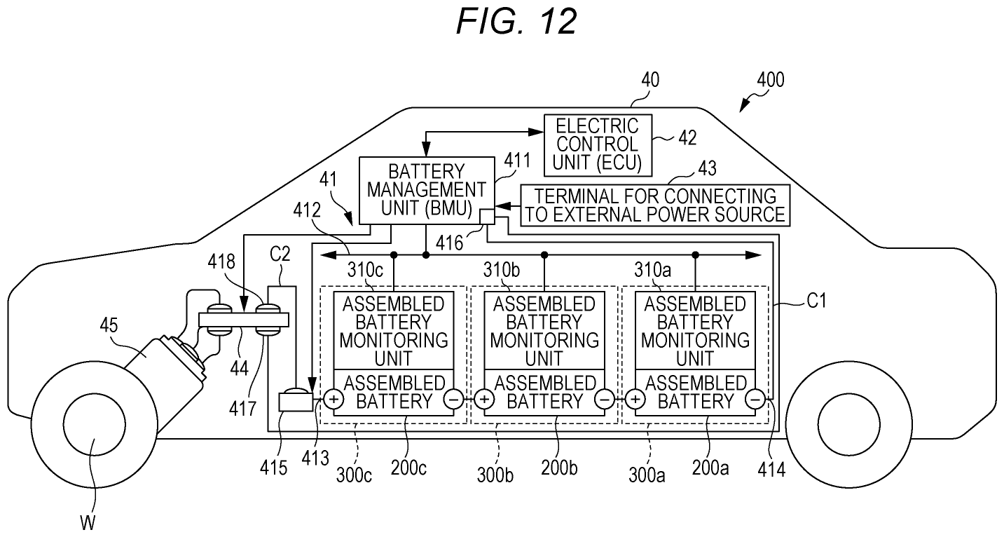

Next, an embodiment of the vehicle according to the fifth embodiment will be described with reference to FIG. 12. FIG. 12 is a diagram schematically illustrating an example of a control system involving an electrical system in the vehicle according to the fifth embodiment. A vehicle 400 illustrated in FIG. 12 is an electric car.

The vehicle 400 illustrated in FIG. 12 includes a vehicle body 40, a vehicle power source 41, and a vehicle electric control unit (ECU) 42, which is a high-order control device of the vehicle power source 41, an external terminal (a terminal for connecting to an external power source) 43, an inverter 44, and a drive motor 45.

In the vehicle 400, the vehicle power source 41 is mounted, for example, in an engine room, rearwardly of the vehicle body of the automobile, or under a seat. Note that in the vehicle 400 illustrated in FIG. 12, where the vehicle power source 41 is mounted is schematically illustrated.

The vehicle power source 41 includes a plurality of (e.g., three) battery packs 300a, 300b, and 300c, a battery management unit (BMU) 411, and a communication bus 412.

The battery pack 300a includes an assembled battery 200a and an assembled battery monitoring unit 310a (e.g., for Voltage Temperature Monitoring (VTM)). The battery pack 300b includes an assembled battery 200b and an assembled battery monitoring unit 310b. The battery pack 300c includes an assembled battery 200c and an assembled battery monitoring unit 310c. The battery packs 300a to 300c are each the same battery pack as the battery pack 300 described above, and the assembled batteries 200a to 200c are each the same assembled battery as the assembled battery 200 described above. The assembled batteries 200a to 200c are electrically connected in series. Each of the battery pack 300a, 300b, or 300c can be independently removed, and can be replaced with another battery pack 300.

Each of the assembled batteries 200a to 200c includes serially connected unit cells. At least one of the unit cells is the secondary battery according to the third embodiment. The assembled batteries 200a to 200c are each charged and discharged through the positive electrode terminal 413 and the negative electrode terminal 414.

The battery management unit 411 communicates with the assembled battery monitoring units 310a to 310c, and collects information on, for instance, the voltage and temperature of each unit cell 100 included in the assembled batteries 200a to 200c contained in the vehicle power source 41. As a result, the battery management unit 411 collects information on maintenance of the vehicle power source 41.

The battery management unit 411 and the assembled battery monitoring units 310a to 310c are connected via the communication bus 412. In the communication bus 412, a set of communication lines is shared by a plurality of nodes (the battery management unit 411 and one or more assembled battery monitoring units 310a to 310c). The communication bus 412 is a communication bus configured based on, for example, a control area network (CAN) standard.

The assembled battery monitoring units 310a to 310c measure the voltages and temperatures of the individual unit cells constituting the assembled batteries 200a to 200c on the basis of a command communicated from the battery management unit 411. However, the temperature may be measured at only several places per assembled battery, and the temperatures of all the unit cells are not necessarily measured.

The vehicle power source 41 may also include an electromagnetic contactor (e.g., a switch unit 415 illustrated in FIG. 12) that switches the presence or absence of electrical connection between the positive electrode terminal 413 and the negative electrode terminal 414. The switch unit 415 includes a precharge switch (not shown) that is turned on when the assembled batteries 200a to 200c are charged, and a main switch (not shown) that is turned on when the output from the assembled batteries 200a to 200c is supplied to a load. The precharge switch and the main switch each include a relay circuit (not shown) that is switched on or off by a signal supplied to a coil disposed near the switch element. The electromagnetic contactor such as the switch unit 415 is controlled on the basis of a control signal from the battery management unit 411 or the vehicle ECU 42 that controls the operation of the entire vehicle 400.

The inverter 44 converts the input DC voltage into a three-phase alternating current (AC) high voltage for driving the motor. A three-phase output terminal of the inverter 44 is connected to a corresponding three-phase input terminal of the drive motor 45. The inverter 44 is controlled on the basis of a control signal from the battery management unit 411 or the vehicle ECU 42 for controlling the operation of the entire vehicle. The output voltage from the inverter 44 is adjusted by controlling the inverter 44.

The drive motor 45 is rotated by power supplied from the inverter 44. The driving force generated by the rotation of the drive motor 45 is transmitted to the axle and the driving wheels W via, for example, a differential gear unit.

Although not illustrated, the vehicle 400 includes a regenerative brake mechanism (regenerator) The regenerative brake mechanism rotates the drive motor 45 when the vehicle 400 is braked, and converts kinetic energy into regenerative energy as electric energy. The regenerative energy recovered by the regenerative brake mechanism is input to the inverter 44 and converted into a direct current. The converted direct current is input to the vehicle power source 41.

One terminal of the connection line L1 is connected to the negative electrode terminal 414 of the vehicle power source 41. The other terminal of the connection line L1 is connected to the negative electrode input terminal 417 of the inverter 44. The connection line L1 is provided with a current detection unit (current detection circuit) 416 in the battery management unit 411 as installed between the negative electrode terminal 414 and the negative electrode input terminal 417.

One terminal of the connection line L2 is connected to the positive electrode terminal 413 of the vehicle power source 41. The other terminal of the connection line L2 is connected to the positive electrode input terminal 418 of the inverter 44. The connection line L2 is provided with a switch unit 415 between the positive electrode terminal 413 and the positive electrode input terminal 418.

The external terminal 43 is connected to the battery management unit 411. The external terminal 43 can be connected to, for example, an external power source.

The vehicle ECU 42 cooperatively controls, for instance, the vehicle power source 41, the switch unit 415, and the inverter 44 together with other management unit(s) and control unit(s) including the battery management unit 411 in response to, for example, a driver's operation input. The vehicle ECU 42 and others may be cooperatively controlled to control, for example, the output of power from the vehicle power source 41 and the charging of the vehicle power source 41. In this way, the entire vehicle 400 is managed. Data on the maintenance of the vehicle power source 41 (e.g., the remaining capacity of the vehicle power source 41) is transferred, via a communication line, between the battery management unit 411 and the vehicle ECU 42.

The battery pack according to the fourth embodiment is mounted on the vehicle according to the fifth embodiment. Since excellent cycle characteristics are achieved in the battery pack, it is possible to provide a highly reliable vehicle.

### Sixth Embodiment

The sixth embodiment provides a stationary power source including the battery pack according to the fourth embodiment.

The stationary power source may be equipped with the secondary battery or the assembled battery according to the third embodiment instead of the battery pack according to the fourth embodiment. The stationary power source according to the embodiment allows for a long life.

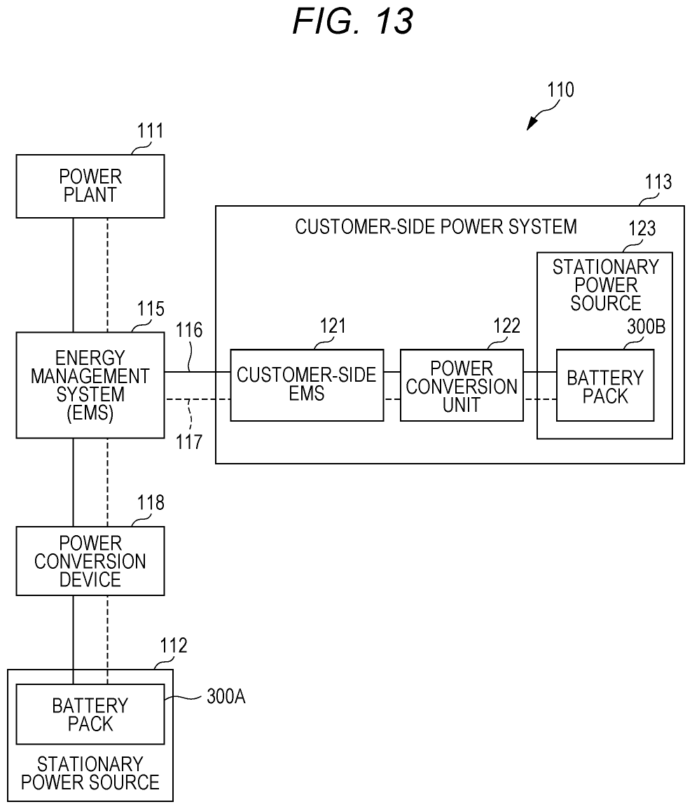

FIG. 13 is a block diagram illustrating an example of a system including a stationary power source according to the sixth embodiment. FIG. 13 is a diagram illustrating an example of application to stationary power sources 112 and 123 as a use example of the battery packs 300A and 300B according to the above embodiment. In the example illustrated in FIG. 13, a system 110 using the stationary power sources 112 and 123 is illustrated. The system 110 includes a power plant 111, a stationary power source 112, a customer-side power system 113, and an energy management system (EMS) 115. In addition, the system 110 has an electric power network 116 and a communication network 117, and the power plant 111, the stationary power source 112, the customer-side power system 113, and the EMS 115 are connected via the electric power network 116 and the communication network 117. The EMS 115 performs control to stabilize the entire system 110 by utilizing the electric power network 116 and the communication network 117.

The power plant 111 generates a large amount of electric power by using, for example, a thermal power or nuclear power fuel source. Electric power is supplied from the power plant 111 through, for instance, the electric power network 116. In addition, a battery pack 300A is mounted on the stationary power source 112. The battery pack 300A can store, for instance, electric power supplied from the power plant 111. In addition, the stationary power source 112 can supply the electric power stored in the battery pack 300A through, for instance, the electric power network 116. The system 110 is provided with a power conversion device 118. The power conversion device 118 includes a converter, an inverter, a transformer, and others. Thus, the power conversion device 118 allows for conversion between direct current and alternating current, conversion between alternating currents with different frequencies, voltage transformation (step-up and step-down), and so on. Therefore, the power conversion device 118 can convert the electric power from the power plant 111 into electric power that can be stored in the battery pack 300A.

The customer-side power system 113 includes, for instance, a power system for a factory, a power system for a building, or a power system for home use. The customer-side power system 113 includes a customer-side EMS 121, a power conversion unit 122, and a stationary power source 123. The battery pack 300B is mounted on the stationary power source 123. The customer-side EMS 121 performs control to stabilize the customer-side power system 113.

The electric power from the power plant 111 and the electric power from the battery pack 300A are supplied to the customer-side power system 113 through the electric power network 116. The battery pack 300B can store the electric power supplied to the customer-side power system 113. In addition, like the power conversion device 118, the power conversion unit 122 includes, for example, a converter, an inverter, and a transformer. Thus, the power conversion unit 122 allows for conversion between direct current and alternating current, conversion between alternating currents with different frequencies, voltage transformation (step-up and step-down), and so on. Therefore, the power conversion unit 122 can convert the electric power supplied to the customer-side power system 113 into electric power that can be stored in the battery pack 300B.

Incidentally, the electric power stored in the battery pack 300B can be used, for example, for charging a vehicle such as an electric vehicle. In addition, the system 110 may also be provided with a natural energy source. In this case, the natural energy source generates electric power by using natural energy such as wind power or sunlight. Then, electric power is supplied from the natural energy source in addition to the power plant 111 through the electric power network 116.

The battery pack according to the fourth embodiment is mounted on the stationary power source according to the sixth embodiment. As a result, this stationary power source allows for excellent cycle characteristics.

### EXAMPLES

Examples will be described below, but the embodiments are not limited to the examples described below.

### Example 1

<To Produce Negative Electrode Active Material>

Nb2O₅ particles and TiO₂ particles were mixed in a molar ratio of 1:1 by using a dry bead mill. The resulting powder was placed in an alumina crucible and heated at a temperature of 800° C. for 10 hours. Thereafter, pulverization and mixing were performed, and pre-calcination was performed again at a temperature of 800° C. for 10 hours to give precursor particles. Further, the obtained precursor particles were subjected to main calcination at 1100° C. for 5 hours to produce Nb2TiO₇ powder.

<Surface Treatment of Active Material>

First, 10 g of the obtained Nb2TiO₇ powder was added to 100 mL of 0.1 mol/L NaOH aqueous solution. The mixture was placed on a hot plate, and then stirred at 80° C. for 3 hours. The solid content was separated by suction filtration to obtain a base-treated Nb2TiO₇ powder. To a recovery flask (50 ml) equipped with a magnetic stirring bar, n-propyltrimethoxysilane (0.96 g) as an alkyl-based silane coupling agent and a mixture (30 ml) obtained by mixing ethanol and water at a volume ratio of 9:1 as a hydrolysis solvent were added, and the resulting mixture was stirred at room temperature for 1.5 hours. In this way, a silane coupling agent-containing solution was prepared.

Another recovery flask (100 ml) equipped with a magnetic stirring bar was provided. To the flask, 3 g of the base-treated Nb2TiO₇ powder and 18 ml of ethanol were added. The mixture was stirred to prepare a dispersion. This dispersion was admixed with the previously prepared silane coupling agent-containing solution, and the mixture was stirred at 80° C. for 1.5 hours. Ethanol was removed by suction filtration, and the solid content was separated. The solvent was distilled away from the separated solid under reduced pressure to obtain silane-coupled Nb2TiO₇ powder.

<Weight Measurement after Base Treatment of Active Material Surface>

Powder was obtained in the same procedure as for the base treatment described above, and then the weight was measured with an analytical balance. Thereafter, the ratio C/B of the weight C after base treatment to the weight B before base treatment of the active material surface was calculated for each of Examples. In Example 1, the weight ratio was 1.0.

<To Produce Negative Electrode>

The previously obtained silane-coupled Nb2TiO₇ (NTO) powder was provided as a negative electrode active material; acetylene black AB was provided as a conductive agent; carboxymethyl cellulose (CMC) sodium salt powder was provided as a thickener; and a styrene butadiene rubber (SBR) dispersion was provided as a binder. These materials were mixed in the following order at a mass ratio of NTO:AB: CMC:SBR=100:5:2:2 while stirring pure water as a solvent to prepare a slurry. The carboxymethylcellulose sodium salt was dissolved in pure water, and SBR was then further mixed to obtain a dispersion. Acetylene black was dispersed in this dispersion, and finally NTO powder was dispersed and stirred to obtain a slurry. This slurry was applied to both surfaces of a current collector made of aluminum foil having a thickness of 12 μm. Next, the resulting slurry coating film was dried and pressed to form a first active material-containing layer. Then, the material was cut so that the surface contour of the first active material-containing layer was rectangular. Provided that a current collecting tab was formed by leaving a portion on one side of the rectangle where the active material-containing layer of the current collector was not formed.

<To Produce Positive Electrode>

First, 3 g of LiNi_{0.5}Co_{0.2}Mn_{0.3}O₂ was provided as a positive electrode active material. Acetylene black AB was provided as a conductive agent and a PVdF dispersion (NMP solution having a solid content of 8%) was provided as a binder (binder resin). These materials were admixed with N-methyl-2 pyrrolidone (NMP) at a mass ratio of NCM:AB:PVdF=20:1:1 to prepare an active material-containing slurry. This slurry was applied to both surfaces of a current collector made of aluminum foil having a thickness of 12 μm. Next, the resulting slurry coating film was dried and pressed to form a first active material-containing layer. Then, the material was cut so that the surface contour of the first active material-containing layer was rectangular. Provided that a current collecting tab was formed by leaving a portion on one side of the rectangle where the active material-containing layer of the current collector was not formed.

<To Produce Electrode Group>

A cellulose separator having a thickness of 15 μm was prepared. A coil body was produced that has a structure in which the separator was interposed between the above-described positive electrode and negative electrode and the resulting material was wound in a spiral shape so as to have a flat shape.

<To Prepare Electrolyte>

Propylene carbonate (PC) and diethyl carbonate (DEC) were mixed at a volume ratio of PC:DEC=1:2 to prepare a mixed solvent. Lithium hexafluorophosphate (LiPF₆) (1.0 M) was dissolved in the mixed solvent to prepare a liquid nonaqueous electrolyte.

<To Assemble Secondary Battery>

The electrode group was housed in a pack made of a laminate film composed of an aluminum foil and polypropylene layers formed on both surfaces of the aluminum foil. Next, the liquid nonaqueous electrolyte was injected into the laminate film pack in which the electrode group was housed. The laminate film pack was completely sealed by heat sealing to produce a battery.

### Example 2

The same procedure as in Example 1 was repeated except that the active material was base-treated using 0.1 mol/L NaOH aqueous solution at 60° C. for 3 hours. In Example 2, the weight ratio was 1.0.

### Example 3

The same procedure as in Example 1 was repeated except that the active material was base-treated using 0.1 mol/L NaOH aqueous solution at 45° C. for 3 hours. In Example 3, the weight ratio was 1.0.

### Example 4

Nb₂O₅ particles, TiO₂ particles, and Ta₂O₅ particles were mixed at a molar ratio of 0.9:1:0.1 by using a dry bead mill. The resulting powder was placed in an alumina crucible and heated at a temperature of 800° C. for 10 hours. Thereafter, pulverization and mixing were performed, and pre-calcination was performed again at a temperature of 800° C. for 10 hours to give precursor particles. Further, the obtained precursor particles were subjected to main calcination at 1100° C. for 5 hours to produce Nb_{1.8}Ta_{0.2}TiO₇ powder. The subsequent procedure was the same as in Example 1 while using the Nb_{1.8}Ta_{0.2}TiO₇ powder. In Example 4, the weight ratio was 1.0.

### Example 5

Nb2O₅ particles, TiO₂ particles, and WO₃ particles were mixed at a molar ratio of 0.95:0.9:0.2 by using a dry bead mill. The resulting powder was placed in an alumina crucible and heated at a temperature of 800° C. for 10 hours. Thereafter, pulverization and mixing were performed, and pre-calcination was performed again at a temperature of 800° C. for 10 hours to give precursor particles. Further, the obtained precursor particles were subjected to main calcination at 1100° C. for 5 hours to produce Nb_{1.9}W_{0.2}Ti_{0.9}O₇ powder. The subsequent procedure was the same as in Example 1 while using the Nb_{1.9}W_{0.2}Ti_{0.9}O₇ powder. In Example 5, the weight ratio was 1.0.

### Example 6

The same procedure as in Example 1 was repeated except that the main calcination temperature at the time of producing Nb₂TiO₇ powder was set to 1000° C. In Example 6, the weight ratio was 1.0.

### Example 7

The same procedure as in Example 1 was repeated except that the main calcination temperature at the time of producing Nb₂TiO₇ powder was set to 1100° C. In Example 7, the weight ratio was 1.0.

### Example 8

The same procedure as in Example 1 was repeated except that KOH was used as the base during treatment of the active material surface. In Example 8, the weight ratio was 1.0.

### Example 9

The same procedure as in Example 1 was repeated except that LiOH was used as the base during treatment of the active material surface. In Example 9, the weight ratio was 1.0.

### Example 10

The same procedure as in Example 1 was repeated except that the active material surface was base-treated using NaOH aqueous solution at a concentration of 1 mol/L. In Example 10, the weight ratio was 1.0.

### Example 11

The same procedure as in Example 1 was repeated except that the active material surface was base-treated while stirring for 1 hour. In Example 11, the weight ratio was 1.0.

### Example 12

The same procedure as in Example 1 was repeated except that the active material surface was base-treated while stirring for 24 hours. In Example 12, the weight ratio was 1.0.

### Example 13

The same procedure as in Example 1 was repeated except that ethyltrimethoxysilane was used as the silane coupling agent during the base treatment of the active material surface. In Example 13, the weight ratio was 1.0.

### Comparative Example 1

The same procedure as in Example 1 was repeated except that the base treatment of the active material powder was omitted. In Comparative Example 1, the weight ratio was 1.0.

### Comparative Example 2

The same procedure as in Example 4 was repeated except that the base treatment of the active material powder was omitted. In Comparative Example 2, the weight ratio was 1.0.

### Comparative Example 3

The same procedure as in Example 5 was repeated except that the base treatment of the active material powder was omitted. In Comparative Example 3, the weight ratio was 1.0.

### Comparative Example 4

The same base treatment as in Example 1 was performed using, as the active material, commercially available SiO₂ powder, followed by weight measurement. In Comparative Example 4, the weight ratio was 0.035.

### Comparative Example 5

The same procedure as in Example 1 was repeated except that the active material was base-treated with 0.01 mol/L NaOH aqueous solution at 25° C. for 1 hour. In Comparative Example 5, the weight ratio was 1.0.

The active material surface was quantitatively analyzed by XPS as described above. In addition, the median diameter D50 of the active material powder particles was measured in triplicate according to the description of the above measurement protocol. The median diameter obtained from the volume-based particle size distribution chart for each measurement was averaged. Table 1 and 2 show the measurement results in each of Examples 1 to 13 and Comparative Examples 1 to 5.

<Constant Current Charge and Discharge Test>

For Examples 1 to 13 and Comparative Examples 1 to 5, each battery was produced, and the test was then promptly started without waiting time. Both charging and discharging were performed at 0.5 C rate. In addition, the time until the current value reached 0.25 C, until the charging time reached 130 minutes, or until the charge capacity reached 170 mAh/g, whichever was earlier, was set as the charging termination condition. Here, 130 min was set to the discharging termination condition.

<To Evaluate Cycle Characteristics>

The cycle characteristics of each of the batteries produced in Examples 1 to 13 or Comparative Examples 1 to 5 were evaluated as follows.

Performing one charging and discharging in the above constant current charging and discharging test was defined as one cycle of charging and discharging; the discharge capacity at cycle 5 was defined as 100%; and the retention rate of the discharge capacity (mAh/g) at cycle 200 after repeating the cycle was defined as cycle characteristics. As a calculation procedure, the following formula was used for the calculation:

Cycle characteristics (%)=Discharge capacity at cycle 200 (mAh/g)/Discharge capacity at cycle 5 (mAh/g)×100.

Table 1 and 2 show the results of evaluating the cycle characteristics.

TABLE 1

| | | Presence or | | | |
|---|---|---|---|---|---|
| | | absence of | | | |
| | | base | | | Retention |
| | | treatment | XPS | | rate |
| | Kind of | of active | peak | | (%) at |
| | active | material | area | D50 | cycle |
| Example | material | surface | ratio | (μm) | 200 |
| Example 1 | Nb₂TiO₇ | ◯ | 0.71 | 3.1 | 83.5 |
| Example 2 | Nb₂TiO₇ | ◯ | 0.51 | 3.1 | 81.1 |
| Example 3 | Nb₂TiO₇ | ◯ | 0.43 | 3.1 | 80.1 |
| Example 4 | Nb_{1.8}Ta_{0.2}TiO₇ | ◯ | 0.65 | 2.9 | 82.8 |
| Example 5 | Nb_{1.9}W_{0.2}Ti_{0.9}O₇ | ◯ | 0.64 | 2.9 | 81.9 |
| Example 6 | Nb₂TiO₇ | ◯ | 0.75 | 2.4 | 85.6 |
| Example 7 | Nb₂TiO₇ | ◯ | 0.45 | 4.2 | 80.0 |
| Example 8 | Nb₂TiO₇ | ◯ | 0.71 | 3.1 | 82.7 |
| Example 9 | Nb₂TiO₇ | ◯ | 0.63 | 3.1 | 82.5 |

TABLE 2

| | | Presence or | | | |
|---|---|---|---|---|---|
| | | absence of | | | |
| | | base | | | Retention |
| | | treatment | XPS | | rate |
| | Kind of | of active | peak | | (%) at |
| | active | material | area | D50 | cycle |
| Example | material | surface | ratio | (μm) | 200 |
| Example 10 | Nb₂TiO₇ | ◯ | 0.69 | 3.1 | 82.1 |
| Example 11 | Nb₂TiO₇ | ◯ | 0.64 | 3.1 | 82.5 |
| Example 12 | Nb₂TiO₇ | ◯ | 0.68 | 3.1 | 82.2 |
| Example 13 | Nb₂TiO₇ | ◯ | 0.69 | 3.1 | 83.5 |
| Comparative | Nb₂TiO₇ | X | 0.32 | 3.1 | 77.5 |
| Example 1 | | | | | |
| Comparative | Nb_{1.8}Ta_{0.2}TiO₇ | X | 0.29 | 2.9 | 76.9 |
| Example 2 | | | | | |
| Comparative | Nb_{1.9}W_{0.2}Ti_{0.9}O₇ | X | 0.28 | 2.9 | 76.9 |
| Example 3 | | | | | |
| Comparative | SiO₂ | ◯ | — | — | — |
| Example 4 | | | | | |
| Comparative | Nb₂TiO₇ | ◯ | 0.18 | 3.1 | 77.2 |
| Example 5 | | | | | |

In Examples 1 to 13, the monoclinic niobium-titanium-based oxide particles were measured by XPS. The ratio A of the Si2p peak area to the Nb3d peak area was found to satisfy 0.40≤A≤1.0, indicating that the increased cycle characteristics were successfully achieved. Among them, Example 1, Examples 4 to 6, and Examples 8 to 13, in which the peak area ratio A was in the most preferable range (0.60≤A≤0.80), were found to have the best cycle characteristics. Example 2, in which the peak area ratio A was in the preferable range (0.50≤A≤0.90), was found to have the second best cycle characteristics. Finally, Examples 3 and 7, in which the peak area ratio A was in the range of 0.40≤A≤1.0, were found to have favorable cycle characteristics.

Examples 1 to 3 and Examples 6 to 13 were compared with Comparative Example 1, Example 4 was compared with Comparative Example 2, and Example 5 was compared with Comparative Example 3. Silane coupling treatment was performed without base treatment of the active material surface. In this case, Comparative Examples 1, 2, and 3, where the peak area ratio A in the XPS did not fall within the range of 0.40≤A≤1.0, were found to have lower cycle characteristics than the Examples.

Examples 1 to 13 were compared with Comparative Example 4. The case of using SiO₂ as the active material was found to have lower cycle characteristics than Examples 1 to 13. This may be because SiO₂ differs from NTO and has lower resistance to a base, so that the surface base treatment causes dissolution of SiO₂ itself. The results of the weight measurement after the base treatment of the active material surface as described above also show that the SiO₂ surface was dissolved. In addition, the cycle characteristics in Comparative Example 4 became unmeasurable because SiO₂ was dissolved in the base. In addition, high nickel NCM (nickel-cobalt-manganese oxide) was used as an active material and the surface of the NCM was base-treated. In this case, it is considered that the cycle characteristics are deteriorated due to low resistance to a base. This seems to be because a Li₂CO₃ film is generated by the reaction between CO₂ dissolved in the aqueous base solution and the surface Li.

Examples 1 to 13 were compared with Comparative Example 5. The conditions for the base treatment of the active material surface involved that the concentration of the aqueous solution using NaOH, KOH, LiOH or NH₄OH was set to 0.1 to 1.0 mol/L and stirring was performed at a temperature of 45° C. or more and 80° C. or less for 1 hour or more and 24 hours or less. In this case, Examples 1 to 13 were found to have higher cycle characteristics than Comparative Example 5. This is because the surface of the active material was sufficiently coated at the time of the surface treatment by silane coupling under the above base treatment conditions. The XPS revealed that the peak area ratio A (the Si2p peak area/the Nb3d peak area) was 0.40≤A≤1.0.

For the niobium-titanium-based oxide according to an embodiment, the niobium-titanium-based oxide particles were measured by X-ray photoelectron spectroscopy. The ratio A of the Si2p peak area to the Nb3d peak area satisfies 0.40≤A≤1.0, provided that the ratio A is the Si2p peak area/the Nb3d peak area. As a result, the covering of the active material surface can be improved and the water content can be decreased. This can increase the cycle characteristics of the secondary battery having the electrode containing the niobium-titanium-based oxide in the active material. In addition, it is possible to achieve excellent cycle characteristics in a battery pack having this secondary battery, a vehicle on which the battery pack is mounted, and a stationary power source including the battery pack.

Although some embodiments of the present invention have been described, these embodiments have been presented as examples, and are not intended to limit the scope of the invention. These novel embodiments can be implemented in various other forms, and various omissions, substitutions, and changes can be made without departing from the gist of the invention. These embodiments and modifications thereof are included in the scope and gist of the invention, and are included in the invention described in the Claims and the equivalent scope thereof.

Hereinafter, some features according to the embodiments will be supplementarily described.

[1] A niobium-titanium-based oxide comprising niobium-titanium-based oxide particles, wherein an Si2p peak area and an Nb3d peak area, as measured by X-ray photoelectron spectroscopy for the niobium-titanium-based oxide particles, satisfy a ratio A of 0.40≤A≤1.0, provided that the ratio A is the Si2p peak area/the Nb3d peak area.

It is also provided, A niobium-titanium-based oxide satisfying a ratio A of a peak area of Si2p to a peak area of Nb3d is 0.40≤A≤1.0, measured in X-ray photoelectron spectroscopy for a particle of the niobium-titanium-based oxide, wherein the ratio A is the peak area of Si2p/the peak area of Nb3d.

[2] The niobium-titanium-based oxide according to [1], wherein the niobium-titanium-based oxide is at least one selected from the group consisting of a composite oxide represented by general formula LiₓTi_{1-y}M1_{y}Nb_{2-z}M2_{z}O_{7+δ} and a composite oxide represented by general formula LiₓTi_{1-y}M3_{y+z}Nb_{2-z}O_{7-δ}, where M1 is at least one selected from the group consisting of Zr, Si, and Sn; M2 is at least one selected from the group consisting of V, Ta, Bi, K, Ca, B, Co, Fe, Mn, Ni, Si, P, and Mo; M3 is at least one selected from Mg, Fe, Ni, Co, W, Ta, and Mo; and 0≤x≤5, 0≤y<1, 0≤z≤0.5, and −0.3≤δb≤0.3.

[3] The niobium-titanium-based oxide according to [1] or [2], wherein in a particle size distribution chart of the niobium-titanium-based oxide particles as obtained by a laser diffraction scattering method, a median diameter D50 is 0.5 μm or more and 4.0 μm or less.

[4] An electrode comprising, in an active material, the niobium-titanium-based oxide according to any one of [1] to [3].

[5] A secondary battery comprising the electrode according to [4] as a negative electrode, a positive electrode, and an electrolyte.

[6] A battery pack comprising the secondary battery according to [5].

[7] The battery pack according to [6], further comprising an external power distribution terminal and a protection circuit.

[8] The battery pack according to [6] or [7], comprising a plurality of the secondary batteries, wherein the secondary batteries are electrically connected in series, in parallel, or in combination of series and parallel.

[9] A vehicle comprising the battery pack according to any one of [6] to [8].

[10] The vehicle according to [9], comprising a mechanism for converting kinetic energy of the vehicle into regenerative energy.

[11] A stationary power source comprising the battery pack according to any one of [6] to [8].

[12] A niobium-titanium-based oxide comprising niobium-titanium-based oxide particles, wherein a ratio of a peak area of a region from 95 to 110 eV and a peak area of a region from 203 to 214 eV, as measured by X-ray photoelectron spectroscopy for the niobium-titanium-based oxide particles, is 0.40 or more and 1.0 or less where the ratio is the peak area of a region from 95 to 110 eV/the peak area of a region from 203 to 214 eV.

The items [2] to [11] are possible to apply to the item [12].

What is claimed is:

1. A niobium-titanium-based oxide, comprising:
niobium-titanium-based oxide particles,
wherein an Si2p peak area and an Nb3d peak area, as measured by X-ray photoelectron spectroscopy for the niobium-titanium-based oxide particles, satisfy a ratio A of 0.40≤A≤1.0, provided that the ratio A is the Si2p peak area/the Nb3d peak area.

2. The niobium-titanium-based oxide according to claim 1, wherein the niobium-titanium-based oxide is at least one selected from the group consisting of a composite oxide represented by general formula LiₓTi_{1-y}M1_{y}Nb_{2-z}M2_{z}O_{7+δ} and a composite oxide represented by general formula LiₓTi_{1-y}M3_{y+z}Nb_{2-z}O_{7-δ}, where M1 is at least one selected from the group consisting of Zr, Si, and Sn;
M2 is at least one selected from the group consisting of V, Ta, Bi, K, Ca, B, Co, Fe, Mn, Ni, Si, P, and Mo;
M3 is at least one selected from Mg, Fe, Ni, Co, W, Ta, and Mo; and
0≤x≤5, 0≤y<1, 0≤z≤0.5, and −0.3≤δ≤0.3.

3. The niobium-titanium-based oxide according to claim 1, wherein in a particle size distribution chart of the niobium-titanium-based oxide particles as obtained by a laser diffraction scattering method, a median diameter D50 is 0.5 μm or more and 4.0 μm or less.

4. An electrode comprising, in an active material, the niobium-titanium-based oxide according to claim 1.

5. A secondary battery comprising the electrode according to claim 4 as a negative electrode, a positive electrode, and an electrolyte.

6. A battery pack comprising the secondary battery according to claim 5.

7. The battery pack according to claim 6, further comprising an external power distribution terminal and a protection circuit.

8. The battery pack according to claim 6, comprising a plurality of the secondary batteries, wherein the secondary batteries are electrically connected in series, in parallel, or in combination of series and parallel.

9. A vehicle comprising the battery pack according to claim 6.

10. A stationary power source comprising the battery pack according to claim 6.

11. A niobium-titanium-based oxide, comprising:
niobium-titanium-based oxide particles,
wherein a ratio of a peak area of a region from 95 to 110 eV and a peak area of a region from 203 to 214 eV, as measured by X-ray photoelectron spectroscopy for the niobium-titanium-based oxide particles, is 0.40 or more and 1.0 or less where the ratio is the peak area of a region from 95 to 110 eV/the peak area of a region from 203 to 214 eV.

12. The niobium-titanium-based oxide according to claim 11, wherein the niobium-titanium-based oxide is at least one selected from the group consisting of a composite oxide represented by general formula LiₓTi_{1-y}M1_{y}Nb_{2-z}M2_{z}O_{7+δ} and a composite oxide represented by general formula LiₓTi_{1-y}M3_{y+z}Nb_{2-z}O_{7-δ}, where M1 is at least one selected from the group consisting of Zr, Si, and Sn;
M2 is at least one selected from the group consisting of V, Ta, Bi, K, Ca, B, Co, Fe, Mn, Ni, Si, P, and Mo;
M3 is at least one selected from Mg, Fe, Ni, Co, W, Ta, and Mo; and
0≤x≤5, 0≤y<1, 0≤z≤0.5, and −0.3≤δ≤0.3.

13. The niobium-titanium-based oxide according to claim 11, wherein in a particle size distribution chart of the niobium-titanium-based oxide particles as obtained by a laser diffraction scattering method, a median diameter D50 is 0.5 μm or more and 4.0 μm or less.

14. An electrode comprising, in an active material, the niobium-titanium-based oxide according to claim 11.

15. A secondary battery comprising the electrode according to claim 14 as a negative electrode, a positive electrode, and an electrolyte.

16. A battery pack comprising the secondary battery according to claim 15.

17. The battery pack according to claim 16, further comprising an external power distribution terminal and a protection circuit.

18. The battery pack according to claim 16, comprising a plurality of the secondary batteries, wherein the secondary batteries are electrically connected in series, in parallel, or in combination of series and parallel.

19. A vehicle comprising the battery pack according to claim 16.

20. A stationary power source comprising the battery pack according to claim 16.
